(19) United States
(12) Patent Application Publication
(10) Pub. No.: US 2012/0030015 A1
(43) Pub. Date: Feb. 2, 2012

(54) AUTOMATIC ABSTRACTED CREATIVE GENERATION FROM A WEB SITE

(75) Inventors: Lawrence J. Brunsman, Mountain View, CA (US); Sriram Rajaraman, San Jose, CA (US); Priyendra Deshwal, Mountain View, CA (US); Matthew D. Wytock, San Jose, CA (US); Sheridan Kates, San Francisco, CA (US)

(73) Assignee: GOOGLE INC., Mountain View, CA (US)

(21) Appl. No.: 12/846,540

(22) Filed: Jul. 29, 2010

(51) Int. Cl. G06Q 30/00

(52) U.S. Cl. 705/14.49

(57) ABSTRACT

Methods, systems, and apparatus, including computer programs encoded on computer storage media, that are operable to identify a web page that is to be a basis for an advertisement creative; extract content associated with the web page to create an advertisement for serving in response to a request, extracting including abstracting content extracted so that the advertisement is not specifically descriptive of the web page; create a title for the advertisement; combine a body with the title; and combine with the body a uniform resource locator (URL) for a landing page that is to be associated with the advertisement creative.

### BACKGROUND

This specification relates to providing information relevant to user requests.

Internet search engines identify resources, e.g., Web pages, images, text documents, and multimedia content, in response to queries submitted by users and present information about the resources in a manner that is useful to the users.

A conventional query processing service can include an input control that allows the user to provide a textual input in the form of a search query. In some conventional services, advertisements (ads) or other content can be provided to a user system for presentation in response to a received textual input provided by the user. In some instances, advertisements can be identified based on matches between textual input provided by a user and keywords associated with one or more advertisements.

Publishers can include content provided by third party content providers in publications under the publisher's control. At the time for publication (e.g., rendering), a request can be made to the third party content provider to supply the additional content. For example, an on-line newspaper publisher can include one or more advertisements with their publication. Each advertisement (ad) includes a creative that is typically provided by the advertiser. As another example, a web site includes advertisement slots in one or more web pages of the web site. The advertisement slots may be purchased by advertisers, and an advertisement server system provides the advertisements for display on behalf of the advertisers.

### SUMMARY

This specification describes methods, systems, and apparatus including computer program products for presenting content in response to a user request.

In general, one aspect of the subject matter described in this specification can be embodied in computer-implemented methods that include identifying a web page that is to be a basis for an advertisement creative; extracting content associated with the web page to create an advertisement for serving in response to a request, extracting including abstracting content extracted so that the advertisement is not specifically descriptive of the web page; creating a title for the advertisement; combining a body with the title; and combining with the body a uniform resource locator (URL) for a landing page that is to be associated with the advertisement creative.

These and other embodiments can each optionally include one or more of the following features. The advertisement can be a category advertisement that describes a category of goods or services of which the web page can include at least one specific example. The URL can be for a page associated with the category. The advertisement can be a parent advertisement that describes a parent page that can be at least one level higher in a hierarchy above the web page in a web site hierarchy that can include the web page. The URL can be for the parent page. The URL can be for the web page. Abstracting content extracted can include determining extracted content selected from the group of at least one of a title associated with the web page, a header associated with the web page or emphasized content associated with the web page.

The method can further include abstracting the extracted content. Abstracting the extracted content can include determining a category associated with a specific product or service described by the web page. The method can further include using the category in determining the title of the advertisement. The method can further include determining a category page associated with the category and extracting content from the category page for use in creating the advertisement. The method can further include using content extracted from the category page in creating the title.

Abstracting extracted content can include determining a parent associated with the web page. The method can further include using the parent in determining the title of the advertisement. The method can further include determining a parent page associated with the parent and extracting content from the parent page for use in creating the advertisement. The method can further include using content extracted from the parent page in creating the title. The request can be a query. The request can be a request for one or more advertisements to be published along with other content on a serving page. The body can include two lines and can be based on content on the web page. The body can include two lines and can be generic and not specifically related to the web page.

Extracting can include identifying text that can be in a larger font than other text in the web page. Extracting can include identifying anchors associated with the web page. Extracting can include identifying bi-grams and/or other n-grams in the extracted content. Extracting can include identifying a title of the web page; identifying and stripping non-essential material from within the title to create a stripped title; and segmenting the stripped title into known compounds to create an extracted title. Creating the title for the advertisement creative can include computing the intersection between the request and the extracted title.

Creating the title for the advertisement can include generating all possible title snippets using a number of algorithmic rules; scoring the title snippets; and selecting a best snippet from the scored snippets for use as the advertisement creative title. Combining a body can include combining a best title with generic text. Combining a URL can include combining a URL for an advertiser associated with the web page and link to a specific page to the body.

In general, another aspect of the subject matter described in this specification can be embodied in computer-implemented methods that include identifying a content item from a content source that is to be a basis for an advertisement creative; extracting content associated with the content item to create an advertisement for serving in response to a request, extracting including abstracting content extracted so that the advertisement is not specifically descriptive of the content item; creating an advertisement creative title for the advertisement creative based on the request and the extracted content; combining a body with the advertising creative title; and combining with the body a uniform resource locator (URL) for a landing page that is to be associated with the advertisement creative.

These and other embodiments can each optionally include one or more of the following features. The advertisement can be a category advertisement that describes a category of goods or services of which the content item can include at least one specific example. The URL can be for a page associated with the category. The advertisement can be a parent advertisement that describes a parent content item that can be at least one level higher in a hierarchy above the content item in a hierarchy that can include the content item. The URL can be for the parent content item. The URL can be for the content item.

Abstracting content extracted can include determining extracted content selected from the group of at least one of a title associated with the content item, a header associated with the content item or emphasized content associated with the content item. The method can further include abstracting the extracted content. Abstracting the extracted content can include determining a category associated with a specific product or service described by the content item. The method can further include using the category in determining the title of the advertisement. The method can further include determining a category page associated with the category and extracting content from the category page for use in creating the advertisement. The method can further include using content extracted from the category page in creating the title. Abstracting the extracted content can include determining a parent associated with the content item. The method can further include using the parent in determining the title of the advertisement. The method can further include determining a parent content item associated with the parent and extracting content from the parent content item for use in creating the advertisement. The method can further include using content extracted from the parent content item in creating the title.

The request can be a query. The request can be a request for one or more advertisements to be published along with other content on a serving page. The body can include two lines and can be based on content included in the content item. The body can include two lines and can be generic and not specifically related to the content item. Extracting can include identifying text that can be in a larger font than other text in the content item. Extracting can include identifying anchors associated with the content item. Extracting can include identifying bi-grams and/or other n-grams in the extracted content.

Extracting can include identifying a title of the content item; identifying and stripping non-essential material from within the title to create a stripped title; and segmenting the stripped title into known compounds to create an extracted title. Creating the title for the advertisement creative can include computing the intersection between the request and the extracted title. Creating the title for the advertisement creative can include generating all possible title snippets using a number of algorithmic rules; scoring the title snippets; and selecting a best snippet from the scored snippets for use as the advertisement creative title. Combining a body can include combining a best title with generic text. Combining a URL can include combining a URL for an advertiser associated with the content item and link to a specific page to the body.

Particular embodiments of the subject matter described in this specification can be implemented so as to realize none, one or more of the following advantages. Portions of web pages that are relevant to the automatic generation of ad creatives can be identified. Abstracted ad creatives can be automatically generated using information extracted from one or more of target pages, parent pages, category pages, sibling pages, and other associated pages. Abstracted ad creatives that relate to a particular category of products or services can be generated from a page that relates to a specific product or service. Ad creatives and ad creative titles can be ranked to identify the highest ranked ad creatives or ad creative titles. Advertisements can be provided for a web page without the need for an advertiser to provide an ad creative for the web page. Highly relevant ad creatives can be automatically generated and identified. Ad creatives that are specific to individual queries can be automatically generated. Ad creatives can be displayed along side search results or other content requested by an end user without matching a user query or other ad request to keywords provided by an advertiser. One or more abstracted ad creatives can be automatically generated for a target web page and include content that is abstracted from content that is included in the target web page. An abstracted ad creative can point to the target web page (e.g., can include a link to the target web page). An abstracted ad creative can point to a parent page associated with the target web page in a web site structure. An abstracted ad creative can be of the form of a category ad creative that represents an ad creative that can be used for a category of goods or services associated with the target web page.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for determining and providing query results and/or associated content in response to user input.

FIG. 2 illustrates an example commercial landing page and an example advertisement creative generated in association with the commercial landing page.

FIG. 3 illustrates an example architecture for a query processing service system.

FIG. 4 illustrates an example method for generating an abstracted advertisement creative using information extracted from a web page.

FIG. 5 illustrates an example hardware configuration.

Like reference numbers and designations in the various drawings indicate like elements.

### DETAILED DESCRIPTION

The following disclosure describes systems, methods, and apparatus for providing advertisements derived from web pages (e.g., commercial landing pages) where the sponsor of the web page is not required to provide one or more of keywords and/or creatives. The advertisements derived from web pages can be served in response to a user submitted query and be displayed alongside search results for the user submitted query. Alternatively, the advertisements can be provided in response to a request for advertisements and published along with other content of a publisher. In some implementations, the target web pages comprise commercial landing pages that provide information on purchasable products or services, or web pages that facilitate the purchasing of products or services. For example, a commercial landing page can be a page describing a particular brand of car polish. As another example, a commercial landing page can be a web page that allows a user to purchase a particular style of dress.

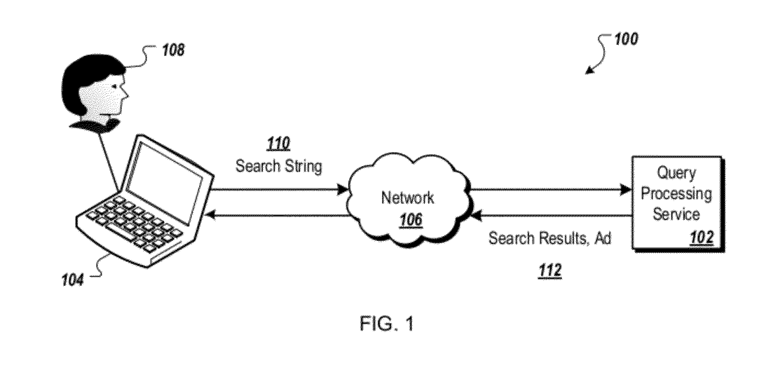

FIG. 1 illustrates an example system 100 for determining and providing query results and/or associated content in response to user input. The associated content can be of the form of Web content and/or Web-based advertisements (or “ads”) that are associated with the query. Non-ad Web content can include links to web sites or other content, news, weather, images, video, auctions, related information, answers to questions, or other information. The identification of associated ad content is described in greater detail below.

The system 100 includes a query processing service 102 that is communicatively coupled to a client device 104 via a network 106. The query processing service 102 can be any content provider or search engine provider, such as Google Search, that provides content and/or ads in response to user queries, inputs or other selections. Other forms of service are possible. The query processing service 102 can be accessible from applications running on the client device 104, such as coupled to (or in communication with) the user's Web browser, any search input dialog, and so forth. The information returned by the query processing service 102 can include search results for a user entered search query, and content (e.g., advertisements) that may correspond to the search results. In some implementations, the system 100 can be used to provide search results and ad content in response to input that the user has provided in applications other than Web browsers, such as input boxes or other controls used in support of other applications (e.g., forms used in online shopping applications). In some implementations, the system 100 can be used to provide relevant ads in response to processing a query that is of the form of an ad request.

In some implementations, system 100 receives user input, typically in a control (e.g., a search query box) that is presented on a user interface associated with the client device 104. The control can be of the form of a textual input box or other input mechanism that is configured to receive user input. In some implementations, the user input is of the form of textual characters, tokens or other input that make up a request. The user input can include numbers, letters, symbols, or other identifiers. The request can be of the form of a search query. The client device 104 can provide the user input, by way of the network 106, to the query processing service 102. In return, in some implementations, the query processing service 102 can provide search results along with other content back to the client device 104. While the system shown includes a remote query processing service 102 that is linked by way of the network 106, portions of the query processing service 102 can be included in the client device 104. While the system is described with reference to a query processing service, other forms of user requests and other services can be provided in support of a given user input.

In some implementations, additional content that is provided by the query processing service 102 along with search results includes one or more ads for presentation (e.g., along with the search results or with other publisher content). The ads provided by the query processing service 102 can link to web pages associated with one or more advertisers. In some implementations, the web pages are commercial landing pages. The commercial landing pages can be web pages that provide information on purchasable products or services offered by advertisers, or web pages that facilitate the purchasing of products or services offered by advertisers. In some implementations, one or more of the ads provided by the query processing service 102 are associated with keywords. The ads can be identified as being relevant to a user entered query based on matches between the query and the keywords associated with the ads. The keywords can be provided by the advertiser or developed by the query processing service 102 as described in greater detail below.

In some implementations, one or more of the ads provided by the query processing service 102 are not associated with keywords that have been provided by a respective advertiser. For example, a particular advertiser may not possess the resources to provide keywords in association with ads or commercial landing pages. In some implementations, prior search queries that were resolved to a given commercial landing page can be used along with one or more terms in a received query to identify commercial landing pages that are relevant to the received query. In some implementations, ad creatives can be automatically generated based on information extracted from the commercial landing pages. The automatically generated creatives can then be provided by the query processing service 102 in response to user entered queries.

In an example scenario of the system 100, the user 108 can enter a search string 110 using an input device of the client device 104. The client device 104 transmits the search string 110 to the query processing service 102 through the network 106. The query processing service 102 uses the received search string 110 to identify one or more commercial landing pages that are relevant to the search string 110. In some implementations, the query processing service 102 can identify relevant commercial landing pages by performing a search of commercial landing pages associated with advertisers that have contracted with the query processing service 102 to provide ads in association with commercial landing pages on behalf of the advertisers. For example, a number of advertisers can identify web sites or web pages for which advertisements are to be supplied by the query processing service 102 without providing keywords for the commercial landing pages. The query processing service 102 can identify commercial landing pages included in the indicated web sites and web pages. In some implementations, an advertiser can indicate a web site that includes commercial landing pages for which ads are to be supplied, and further indicate web pages included within the web site for which ads are not to be supplied. For example, one or more web pages included in a web site may not include any information for purchasable products or services.

The query processing service 102 can perform a search of the identified commercial landing pages to determine if the search string 110 is relevant to any of the commercial landing pages. The query processing service 102 can provide search results 112 for the search string 110 along with ads associated with the identified commercial landing pages to the client device 104 for presentation to the user 108. In some implementations, the query processing service 102 can generate the provided ads using information extracted from the commercial landing pages. For example, the query processing service 102 can extract a title or header from a commercial landing page and derive text for an ad from the extracted title or header. The query processing service 102 can additionally extract one or more images or logos from the commercial landing page to include in the provided ad. In some implementations, the provided ad includes a link back to the commercial landing page.

In some implementations, abstract ad creatives are automatically generated. An abstract ad creative can be generated based on content in a target web page (e.g., a particularly identified commercial landing page that has been mapped to a received query). In some implementations, an abstracted ad creative is of the form of a parent ad creative. In some implementations, a parent ad creative includes content associated with a parent (either actually parent or linking source) to a given target page. The parent landing page can be directly linked to the target page or in a breadcrumb trail to the target page. For example, the parent landing page can link to a secondary page that in turn links to the target page. In this example, although the parent landing page does not link directly to the target page, the parent landing page is included in a breadcrumb trail of pages that lead to the target page. The parent landing page can therefore be classified as a parent of the target page even though the parent landing page does not directly link to the target page.

In a web site hierarchy, the parent of a target page can be a next highest level in the hierarchy towards the root entry or home page. For example, the target page can be a web page for a particular type of golf shoe and the parent page can be a page that links to pages associated with various types of golf shoes that are produced by the same manufacturer, including the target page. The parent page is identified as a parent page since it is the next highest page in the web site hierarchy. As another example, a page can link to pages that are associated with various different golf shoe manufacturers, including the previously identified parent page. This page, that links to the first parent page, can additionally be identified as a parent page since it is part of a breadcrumb trail to the target page.

In some implementations, the parent page can be a page that links to the target page without being the next highest level in the hierarchy towards the root entry or home page for the web site. For example, a web page of the web site can be associated with a particular brand of golf bag. The web page associated with the golf bag can include links to pages featuring products that are often purchased by users who purchased the golf bag. The pages linked to by the web page associated with the golf bag can include the target page associated with the particular type of golf shoe. The web page associated with the golf bag can be identified as a parent page for the target page since the web page associated with the golf bag links to the target page, even though it is not located directly above the target page within the web site hierarchy. In some implementations, the parent page can be a root page for a web site. For example, the target page can be included in a web site for an electronics distributor and include information for a particular type of DVD player. The root page for the electronics web site can be identified as a parent page for the target page. In some implementations, multiple pages can be identified as parent pages for a single target page.

In some implementations an abstracted ad creative can be of the form of a category ad creative. A category ad creative can include content for a category of products or services associated with a target page. For example, the category ad creative can include content derived from an identified commercial landing page that is abstracted so as not to be specific to the particular category element that is described in the identified commercial landing page. For example, a target landing page can include information for a particular type of mp3 player. Information can be extracted from the target landing page. The information can be abstracted so that information that is specific to the particular type of mp3 player is removed. In this example, the abstracted information can be used to generate an abstract ad creative that is directed toward mp3 players in general, or a manufacturer that makes the particular mp3 player associated with the target page, but not directed specifically toward the particular mp3 player. For example, the abstracted ad creative can include a brand name for the mp3 player without including a specific model name for the mp3 player.

In some implementations, a category for the target page can be identified based on information extracted from the target page. Following the example where the target landing page is associated with a specific model of mp3 player, the category for the target landing page can be identified as mp3 players. The identified category of mp3 players can be used in generating an abstracted ad creative in association with the target landing page. For example, the category can be used as a title for the abstracted ad creative, or used to generate a title for the abstracted ad creative. Following the above example, the category of “mp3 players” can be used as a title for an abstracted ad creative for the target landing page associated with the specific mp3 player model.

In some implementations, a category page can be identified in association with a target page. In some implementations, a category page can include information on a general category of products or services that includes a specific product or service described by the target landing page. For example, a web page associated with various types of cars can be identified as a category page for a target landing page associated with a particular car model. In some implementations, a web page can be both a parent page and a category page for a target page. For example, a web page identified as a category page can also link to a target page or be included in a breadcrumb trail for the target page. In some implementations, a parent page is not necessarily a category page and a category page is not necessarily a parent page if it does not link to (either directly or indirectly) the target page. In some implementations, an abstracted ad creative includes a link to a parent page or category page (e.g., a URL associated with the parent page or category page). In some implementations, an abstracted ad creative includes a link to the specific target page (e.g., the specific commercial landing page that is used to create the abstracted ad creative).

For example, the search string 110 can include the terms “golf shoes” and several commercial landing pages for various different models of golf shoes can be identified as being relevant to the query. The commercial landing pages can all be for golf shoes sold by the same golf shoe manufacturer. A web page of the golf shoe manufacturers web site can link to all of the identified commercial landing pages for the individual shoe models. The web page that links to the identified pages can be identified as a parent page. In some implementations, the URL or address for the parent page can be included in the provided ad rather than a link to a particular target page. As another example, a category page can be identified for the target page associated with a specific golf shoe. The URL of the category page can be included in the provided ad.

In some implementations, an ad creative can be generated using information extracted from the parent page, a category page, or from a sibling page (e.g., other pages that are directly or indirectly linked to by a parent page). For example, an abstracted ad for a target page associated with a specific type of golf shoe can be generated using information extracted from a parent page for the target page. In some situations, a parent page can include information that is relevant to a particular product while not being specific to the product. For example, the parent page can include information associated with “Brand ABC Golf Shoes” while the target landing page and other pages linked to by the parent page include information about specific shoe models. The information associated with the general shoe brand that is included in the parent page is used to generate the abstracted ad creative.

As another example, several sibling pages for the target page can be identified. Information can be extracted from each of the sibling pages and the target page. Information that is common to each of the sibling pages and the target page can be identified as abstract information and used in generating an abstracted ad creative. Information that is exclusive to each of the sibling pages and target page can be identified as too specific and discarded for the purposes of generating an abstracted ad creative. In some implementations, information can be extracted from pages that link to a category page or that are linked to by a category page and used to generate an abstracted ad creative. In some implementations, one or more of a target page, parent pages, sibling pages, category pages, or pages that link to or are linked by category pages can be used as sources of information for generating abstracted ad creatives. In some implementations, information from various sources can be compared to identify abstract data and to eliminate data that is too specific to a particular target page, service, or product. How content is extracted and used in creating an abstracted ad creative is described in greater detail below.

In some implementations, multiple target landing pages can be identified for a query, and a parent page or category page can be identified in association with the multiple identified target landing pages. For example, multiple commercial landing pages can be identified as being relevant to the search string 110 and several of the identified commercial landing pages can be linked to by a single web page. The single web page can be identified as a parent page for the identified web pages to which it links. As another example, multiple identified commercial landing pages can all be associated with a particular category of products or services. The category can be identified based on the multiple identified commercial landing pages. The identified category can then be used to identify a category page that is associated with each of the identified commercial landing pages.

In some implementations, the query processing service 102 can access a database in order to match the search string 110 to one or more commercial landing pages. For example, prior to receiving the search string 110, the query processing service 102 can track previously received search queries and commercial landing pages that the search quires resolved to in order to create a database using queries previously resolved to the commercial landing pages. In some implementations, each query that is received by the query processing service 102 that resolves to at least one commercial landing page associated with an advertiser for which the query processing service 102 provides ads can be stored in the database. Each query stored in the database can point to the one or more commercial landing pages to which the query resolves. For example, each query/commercial landing page pair can be stored as a unique entry in the database.

In some implementations in which queries are associated with commercial landing pages in a database, upon receiving the search string 110 the query processing service 102 can access the database to determine if the search string 110 matches a query stored in the database. If the search string 110 matches a query stored in the database, the query processing service 102 can identify one or more commercial landing pages associated with the query within the database. The query processing service 102 can then provide one or more ads generated from content extracted from the commercial landing pages to the client device 104 along with search results 112. In some implementations, the ads can be generated by the query processing service 102 using information extracted from the commercial landing pages as described above. In some implementations, the ads can include links to the identified commercial landing pages. In some implementations, a generated ad can include a link to a parent or category landing page as described above. In some implementations, the ads can be generated by the query processing service 102 using information extracted from a parent landing page or using information extracted from multiple web pages.

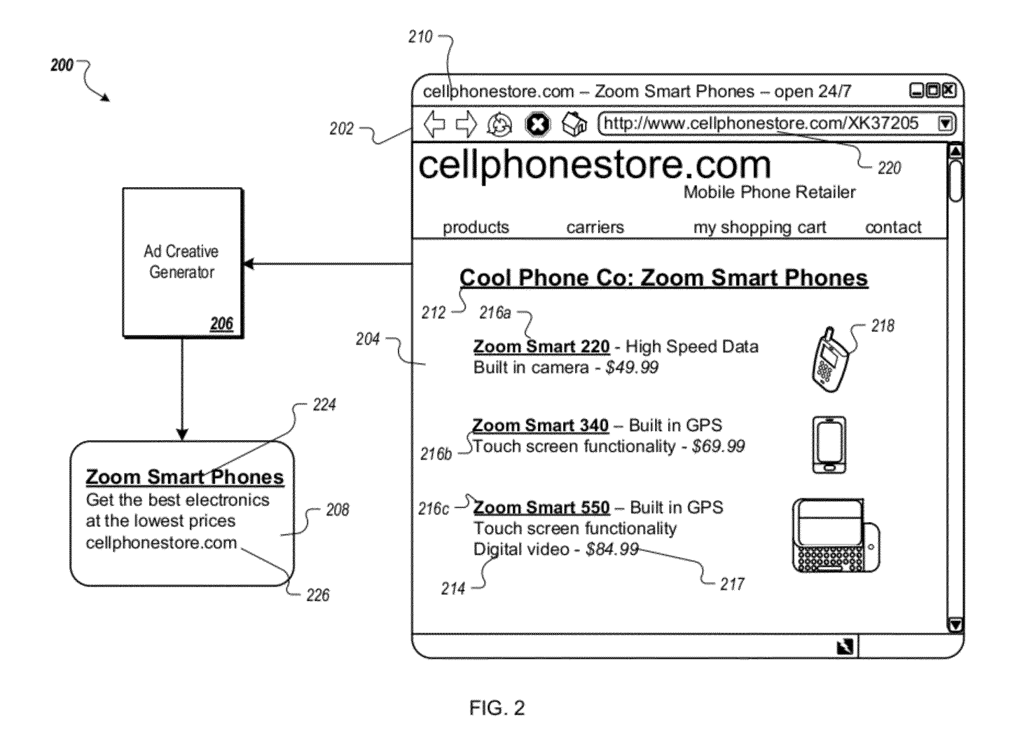

Referring now to FIG. 2, a system 200 includes an application (e.g., a browser 202) displaying a web page 204. The browser 202 can be displayed on a display screen (e.g., an LCD monitor) attached to or in communication with an end user device, such as the client device 104 of FIG. 1. An ad creative generator 206 can extract content from the web page 204 to generate an abstracted ad creative 208. The ad creative generator 206 can identify content extracted from the web page 204 for use in generating the ad creative 208 and other ad creatives. In some implementations, the ad creative 208 can be generated using information extracted from multiple web pages. For example, the ad creative generator 206 can extract information from the web page 204 and one or more additional web pages associated with the web page 204 in order to generate the ad creative 208. In some implementations, the ad creative generator 206 can generate the ad creative 208 using information extracted from a web page linked to by the web page 204 or otherwise associated with the web page 204. For example, the web page 204 can be a parent page for an identified target page. Information extracted from the target page can be used to make the abstracted ad creative 208.

In some implementations, the web page 204 can be identified by a query processing service (e.g., the query processing service 102 of FIG. 1) in response to a received query or ad request. For example, the query processing service can receive a query of “Zoom Smart Phone” and identify the web page 204 as being relevant to the query based on a match between the query and text of the web page 204. In some implementations, a received query can be mapped to the web page 204 within a database. In some implementations, the received query can be mapped to a target page other than the web page 204. For example, the received query can be mapped to a commercial landing page for the Zoom Smart 220 phone. The web page 204 can be identified as a parent page for the identified commercial landing page associated with the Zoom Smart 220 phone since the web page 204 links to the commercial landing page associated with the Zoom Smart 220 phone. In some implementations, the ad creative generator 206 can generate the abstracted ad creative 208 using information extracted from the target landing page. The ad creative generator 206 can remove information that is specific to the Zoom Smart 220 phone from the extracted information in order to identify abstracted information that can be used in generating the abstracted ad creative 208.

In some implementations, the ad creative generator 206 can generate the ad creative 208 using information extracted from the web page 204. In some implementations, the ad creative generator 206 can use information extracted from one or more of the commercial landing pages that are linked to by the web page 204 (e.g., the target landing page and sibling pages) to generate the ad creative 208. In some implementations, the ad creative generator 206 can identify information that is common to each of the pages linked to by the web page 204 in order to generate the abstracted ad creative 208.

In the following sections, extraction of information from a web page will be described with respect to the web page 204. However, similar methods can be used for extracting information from the target page linked to by the web page 204, the sibling pages linked to by the web page 204, other parent pages for the target page (e.g., other pages in the breadcrumb trail leading to the target page), one or more category pages associated with the target page, or one or more web pages associated with a category page.

In some implementations, the ad creative generator 206 can identify a title 210 for the web page 204 as potentially useful for generating an ad creative. In some implementations, the ad creative generator 206 can identify the title 210 by analyzing code used to render the web page 204. For example, the title 210 can be indicated as a title by title tags within HTML code used to render the web page 204. In some implementations, the ad creative generator 206 can identify generic (i.e., boilerplate) portions of the title 210 in order to generate a stripped title for the web page 204. For example, title 210 shown in FIG. 2 is “cellphonestore.com—Zoom Smart Phones—Open 24/7.” The ad creative generator 206 can identify the character strings “cellphonestore.com—” and “—Open 24/7” as generic portions of the title 210. The ad creative generator 206 can remove these character strings from the title 210 to obtain a stripped title for the web page 204.

In some implementations, the ad creative generator 206 can identify generic portions of a web page title using other sources of information. For example, the ad creative generator 206 can access other web pages included in the “cellphonestore.com” web site. The ad creative generator 206 can identify that the character strings “cellphonestore.com—” and “—Open 24/7” are included in a large number of web pages included in the cellphonestore.com web site. The ad creative generator 206 can use this information to determine that the two character strings are generic character strings and should be stripped when creating a stripped title for the web page 204.

In some implementations, when generating an abstracted ad creative, the ad creative generator 206 can strip information that is identified as being too specific from an identified title. For example, the target landing page can include a title of “Zoom Smart Phones: Zoom Smart 220” The ad creative generator 206 can identify the text “Zoom Smart 220” as being specific to a particular product. The ad creative generator 206 can strip the identified text from the title to generate a stripped title of “Zoom Smart Phones.” The remaining text of “Zoome Smart Phones” can be identified as not being too specific to a particular product or landing page and therefore can be identified as appropriate for use in generating an abstracted ad creative. In some implementations, the ad creative generator 206 can identify specific model names, product names, or model numbers as being too specific and strip the identified names or numbers from an identified title. In some implementations, the ad creative generator 206 can identify text within a title as being specific text by comparing the title to information extracted from other web pages to determine that the information in the title is not included in other web pages (and is therefore specific to the identified target web page).

In some implementations, the ad creative generator 206 can identify a header 212 displayed on the web page 204 as potentially useful for generating an ad creative. In some implementations, the ad creative generator 206 can identify the header 212 by analyzing code used to render the web page 204. For example, the header 212 can be indicated as a header by header tags within HTML code used to render the web page 204. In some implementations, the ad creative generator 206 can compare font and other format characteristics of the text of the header 212 to other text included in the web page 204 in order to identify the header 212 as important text. For example, as depicted in FIG. 2, the header 212 is displayed in a larger font than text 214 included in the web page 204. The ad creative generator 206 can identify the header 212 as being important text since the text of the header 212 is larger than the text 214 of the web page 204. The ad creative generator 206 can therefore identify the header 212 as a potential header for the web page 204.

In some implementations, the ad creative generator 206 can identify emphasized (e.g., bolded, underlined, or bolded and underlined) text as being a potential title for the web page 204. For example, as depicted in FIG. 2, the header 212 is bolded and underlined, whereas the text 214 is not bolded or underlined. The header 212 can therefore be identified as a title for the web page 204. Other text attributes that can be used to identify a header, title, or important text within a web page can include other forms of emphasis including italics, specialized coloring, position within the web page (e.g., near the top, near the center, etc.), or a special font (e.g., compared to other text of the web page). In some implementations, the header 212 can include specific text that can be stripped by the ad creative generator 206 as described above for the title 210. For example, if the header is “Zoom Smart Phones—220X” the portion of the header that reads “—220X” can be stripped from the header to create a stripped title that can be used in generating an abstracted ad creative.

In some implementations, multiple segments of text included in the web page 204 can be identified as titles for the web page 204. For example, in addition to identifying the header 212 as a title for the web page 204, the ad creative generator 206 can identify links 216a-c as titles for the web page 204 since each of the links 216a-c are underlined and bolded.

In some implementations, the ad creative generator 206 can identify pricing information included in the web page 204 as potentially useful for generating an ad creative. For example, the ad creative generator 206 can identify the price 217 as a price for the cell phone described in the web page 204. The ad creative generator 206 can, for example, identify the “$” symbol in order to identify the price 217 as a price for the cell phone. In some implementations, pricing information can be identified as being too specific for an abstracted ad creative. In some such cases, the ad creative generator 206 can discard identified pricing information.

In some implementations, the ad creative generator 206 can identify additional text included in the web page 204 as potentially useful for generating an ad creative. For example, the ad creative generator 206 can compare the text 214 to a received query or received keywords associated with an ad request. The received query can be, for example, a user entered search query. The received keywords can be, for example, keywords associated with advertisement slots for web pages. The ad creative generator 206 can compare a query or keywords to the text 214 to identify portions of the text 214 that can be useful for generating an ad creative. For example, if a user enters a query of “Cell Phone with GPS,” the ad creative generator 206 can identify the text “Built in GPS” within the text 214 as being potentially useful for generating an ad creative.

In some implementations, the ad creative generator 206 can identify one or more images or logos included in the web page 204 for use in generating an ad creative. For example, an image 218 can be identified as useful for generating an ad creative. In some implementations, the ad creative generator 206 can identify relevant images based on location within the web page 204. For example, a prominently located image can be identified as more relevant than other images. In some implementations, the ad creative generator 206 can identify a URL for the web page 204 as useful in generating an ad creative. For example, the ad creative generator 206 identifies a URL 220 for use in generating an ad creative. In some implementations, instead of or in addition to identifying the URL 220 for the web page 204, the ad creative generator 206 can identify a URL for a front page of a web site that includes the web page 204 for use in generating an abstracted ad creative. For example, for the URL 220 of “www.cellphonestore.com/XK37205” the ad creative generator 206 can additionally identify a web site URL of “www.cellphonestore.com” or “cellphonestore.com.” In some implementations, the ad creative generator 206 can identify URLs linked to by the links 216a-c (e.g., URLs for the target page and/or the sibling pages) for use in generating an abstracted ad creative. In some implementations, URLs associated with one or more category pages associated with the target page can be identified for us in generating an abstracted ad creative.

In some implementations, the ad creative generator 206 can identify anchor text for the web page 204 as potentially useful for generating an ad creative. In some implementations, an anchor is text associated with a hyperlink that links to a destination web page. For example, a link on a second web page can link to the web page 204. Anchor text for the link on the second web page that links to the web page 204 can read “Lowest Prices on Zoom Smart Phones.” The anchor text extracted from the second web page can be identified by the ad creative generator 206 for use in generating an ad creative for the web page 204. As another example, the text “Zoom Smart 220” is anchor text for a the target page linked to by the link 216a. In some implementations, anchor text can be identified as a potential title for a web page.

In some implementations, the ad creative generator 206 can disregard text of the web page 204 that is identified as too specific. Text that can be identified as too specific can include product numbers, specific product names, product codes, specific product features, product options (e.g., colors, sizes) or in some cases, brand names. For example, the ad creative generator 206 can identify the text “Zoom Smart 220” as being a product name for a specific product and therefore not useful in generating an abstracted ad creative for the target page or the web page 204. As another example, the ad creative generator 206 can identify the text “Digital video” as being related to a specific feature for a specific product and therefore not useful in generating an abstracted ad creative for the web page 204.

As yet another example, the ad creative generator 206 can identify a model number included in text of a web page as not being useful in generating an abstracted ad creative. In some implementations, the ad creative generator 206 can identify the model number as a product number by determining that the model number contains a semi-random string of alphanumeric characters that do not form a word in the English language.

In some implementations, the ad creative generator 206 can extract information from other web pages associated with the web page 204 in order to generate the ad creative 208. For example, the ad creative generator 206 can extract information from the target page as described above for the web page 204. The ad creative generator 206 can discard information identified as specific to a product associated with the target page (e.g., the Zoom Smart 220). For example, information relating to the specific product name (“Zoom Smart 220”), specific product codes, or specific product features can be discarded. The remaining extracted information can be identified as abstracted information and used to generate an abstracted ad creative. In some implementations, only information extracted from the target page is abstracted and used to generated the abstracted ad creative 208. In some implementations, only information extracted from a single parent page (e.g., the web page 204) or category page associated with the target page is used to generate the abstracted ad creative 208. In some implementations, abstracted information gathered from multiple sources (e.g., web pages) can be used to generate the abstracted ad creative 208.

In some implementations, the ad creative generator 206 can extract information from one or more sibling pages linked to by the links 216b-c in order to generate one or more abstracted ad creatives. The ad creative generator 206 can identify titles, headers, and other important text included in the web pages linked to by the links 216b-c as well as images and other information included in the web pages as described above for the web page 204. In some implementations, the information extracted from the sibling pages can be abstracted to remove information that is specific to a specific product or service. In some implementations, one or more web pages can be compared to each other to identify information that is common to the web pages. The common information can be identified as information that is suitable for generating an abstracted ad creative, while information that is not common to the web pages can be identified as too specific.

In some implementations, the ad creative generator 206 can compare information extracted from the web page 204, the target page, and/or web pages associated with the target page (e.g., sibling pages, category pages, additional parent pages) to a received query to identify text and other content to use in generating an ad creative. For example, the ad creative generator 206 can generate the ad creative 208 in response to a received query of “Zoom Smart Phone.” The ad creative generator 206 can compare the received query to the header 212, the title 210 or other text extracted from the web page 204, the target page, or web pages associated with the target page in order to generate a title for the ad creative 208. In some implementations, the ad creative generator 206 compares the received query to various identified text segments extracted from the web page 204 (or other associated web pages) to identify one or more relevant text segments. For example, the ad creative generator 206 can identify the header 212 as having more words in common with the received query than other text associated with the web page 204. Based on this identifying, the ad creative generator 206 can use some or all of the text of the header 212 as a title for the web page 204.

In some implementations, the ad creative generator 206 can divide identified character strings into sub-strings. For example, the ad creative generator 206 can divide the title 210 or a string of anchor text into sub-strings. In some implementations, the ad creative generator 206 can divide character strings into sub-strings by identifying n-grams within the character strings. An n-gram is a sequence of n number of words identified within a character string. An n-gram where n=2 can be referred to as a bigram and an n-gram where n=3 can be referred to as a trigram. The ad creative generator 206 can identify n-grams within character strings in order to determine words within character strings that should not be split apart. For example, the ad creative generator 206 can determine that when the words “surf” and “board” appear together in sequence, the words are used as a single term (i.e., “surf board”) and should not be split up. In some implementations, strings of words can be identified as n-grams based on how often the words appear together over a large set of content. For example, the ad creative generator 206 can determine how often two words appear together within all web pages included in a web site. As another example, the ad creative generator 206 can identify how often two words appear together over a large set of web pages (e.g., an entire web domain, or the Internet).

Still referring to FIG. 2, in the example shown, the ad creative generator 206 can identify n-grams of “Cool Phone Co,” and “Zoom Smart” within the header 212. In this example, “Cool Phone Co” is the name of a cell phone manufacturer, and therefore the three words appear together often and can be identified by the ad creative generator 206 as a trigram. The character string “Zoom Smart” is the name of a particular cell phone model in this example, and can therefore be identified by the ad creative generator 206 as a bigram. The ad creative generator 206 can compare the received query to the header 212 in order to identify one or more n-grams within the header 212 for use in generating an ad creative title 224 for the ad creative 208. For example, for the query of “Zoom Smart Phone,” the ad creative generator 206 can identify the n-gram of “Zoom Smart” as being most relevant to the query and use “Zoom Smart” as or in the ad creative title 224. In some implementations, the ad creative generator 206 can identify the word “Phones” as a stand alone word that is not part of an n-gram. The ad creative generator 206 can identify the word “Phones” as matching the word “Phone” in the query and combine the word “Phones” with the bigram of “Zoom Smart” to generate the ad creative title 224 of “Zoom Smart Phones.”

In some implementations, although an n-gram matches one or more words in a received query, the system may elect to not use the n-gram in the creative. For example, the n-gram “Cool Phone Co” matches the word “Phone” within the example query described above. The ad creative generator 206 can elect not to select the n-gram “Cool Phone Co” for use in the ad creative title 224 since the query does not match the entire n-gram of “Cool Phone Co.” In some implementations, the ad creative generator 206 can identify “Cool Phone Co” as a specific company name and “Phone” as a more general word that can refer to many other terms aside from the company name “Cool Phone Co” and therefore elect to not use the n-gram “Cool Phone Co” in the ad creative title 224.

In some implementations, n-grams can be identified as being specific to a particular product, service, or target page. The identified specific n-grams can then be discarded. For example, the target page can include an identified title of “Zoom Smart 220—Music Capable Smart Phone.” The ad creative generator 206 can identify n-grams of “Zoom Smart 220,” “Music Capable,” and “Smart Phone” in the identified title. The n-gram of “Zoom Smart 220” can be identified as relating to a specific product and therefore discarded. The n-gram of “Smart Phone” can be identified as an abstract n-gram that relates to multiple products or web pages. The n-gram “Smart Phone” can therefore be identified for use in generating an abstracted ad creative. In some implementations, the n-gram “Music Capable” can be identified as relating to a group of cell phones, and therefore suitable for use in generating an abstracted ad creative. In other implementations, the n-gram “Music Capable” can be identified as a specific feature of the Zoom Smart 220 and therefore discarded and not used in generating an abstract ad creative.

In some implementations, an identified category for a web page can be used to generate the ad creative title 224. For example, the category for the target page can be identified as “Zoom Smart Phones” or possibly just “Mobile Phones.” The identified category for the target page can be identified as the ad creative title 224, or as a possible ad creative title for the abstracted ad creative 208.

In some implementations, the ad creative generator 206 can identify all potential ad creative titles that can be derived from information extracted from the target page or pages associated with the target page. The potential ad creative titles can include identified categories, identified n-grams, and identified combinations of n-grams and other text included in the extracted information. The ad creative generator 206 can apply rules to select the ad creative title 224 from among the potential ad creative titles. For example, the ad creative generator 206 can implement a rule to only select potential ad creative titles that begin with a word found within the received query. As another example, the ad creative generator 206 can implement a rule that excludes all potential ad creative titles that reference specific product/service names, product numbers, product codes, or in some cases, specific product features or brand names.

In some implementations, the ad creative generator 206 can apply ranking scores to potential ad creative titles in order to rank the potential ad creative titles and select a best ad creative title from among the potential ad creative titles. Attributes that can be used to rank the potential ad creative titles can include length, number of words, number of n-grams, intersection with a received query (e.g., number of words matched or percentage of words matched), number of prepositions or location of prepositions, number of short words (e.g., articles), number of generic words, references to specific product/service names, references to product numbers or codes, references to specific product/service features, or references to specific brand names in the potential ad creative titles.

For example, the ad creative generator 206 can compare the received query of “Zoom Smart Phone” to the ad creative title 224 of “Zoom Smart” to identify an intersection between the received query and the ad creative title 224. In this example, all of the words included in the ad creative title 224 intersect with words in the query. As a result of the comparison, the ad creative title 224 can be given a relatively high ranking score compared to other potential ad creative titles. Continuing with this example, a potential ad creative title of “Cool Phone Co—Black” Can be given a lower ranking score than the ad creative title 224 since the potential ad creative title “Cool Phone Co—Black” intersects with only one word of the received query. As another example, a potential ad creative title of “Zoom Smart 340” can be given a lower ranking since it includes a specific product number/product name. As yet another example, a potential ad creative title of “Touch Screen Functionality” can be given a lower ranking since it indicates a specific product feature. As yet another example, the potential ad creative title of “Touch Screen Functionality” can be compared to a search query of “Zoom Smart” to determine that there is no intersection between the query and the potential ad creative title. The potential ad creative title can therefore be given a lower ranking since it does not intersect with the search query.

As still another example, long potential ad creative titles that do not exceed a maximum threshold can be given higher ranking scores than potential ad creative titles that are shorter. As another example, a potential ad creative title that includes two n-grams can be given a higher ranking score than a potential ad creative title that includes one or does not include any n-grams. As yet another example, a potential ad creative title that ends in a proposition can be given a lower ranking score than a potential ad creative title that does not end in a preposition. As yet another example, potential ad creative titles that include model numbers, product numbers, or specific product names can be penalized (i.e., given lower ranking scores than other potential ad creative titles). In some implementations, after ranking scores have been determined for potential ad creative titles, one or more ad creative titles having the highest ranking scores can be selected for use in generating one or more abstracted ad creatives.

In some implementations, additional text can be included in ad creatives generated by the ad creative generator 206. In some implementations, the additional text included in an ad creative can be generic text that is used for multiple automatically generated abstracted ad creatives associated with a group of commercial landing pages. The generic text can be associated with a web site without being specifically associated with a web page for which an ad creative is being generated. For example, generic text associated with a web site that includes the web page 204 can be used for some or all of the ad creatives generated in association with web pages included in the web site. In the example shown, the text “Get the best electronics at the lowest prices” can be generic text that is included in all ad creatives that are automatically generated in association with web pages included in the “cellphonestore.com” web site.

In some implementations, additional text included in an automatically generated ad creative can be generated by the ad creative generator 206 using identified character strings associated with the web page 204. The identified character strings can include the title 210, the header 212, the text 214, the price 217, anchor text associated with the web page 204, or any other text or content associated with the web page 204, the target page, or other pages associated with the target page. In some implementations, additional text for ad creatives can be generated as described above for the ad creative title 224. For example, a query of “Zoom Smart touch screen” can be compared to the text 214 to identify an intersection between the search terms “touch screen” and the character string “touch screen functionality.” The ad creative generator 206 can identify the text “touch screen functionality” for inclusion in an automatically generated ad creative as additional text for the ad creative.

In some implementations, the ad creative title 224 and the additional text can be derived from different sources. For example, the ad creative title 224 can be generated using abstracted information extracted from the web page 204, while the additional text is generated using abstracted information extracted from the target page. As another example, the ad creative title 224 can be generated using abstracted information extracted from a category page associated with the target page while the additional text is identified by comparing information extracted from the target page and the sibling pages to identify information that is common to each of the target and sibling pages.

In some implementations, the ad creative generator 206 can generate multiple ad creatives in association with the web page 204. For example, a query processing service (e.g., the query processing service 104 of FIG. 1) can identify each of the pages linked to by the links 216a-c as being relevant to a received query. The query processing service can then identify the web page 204 as a parent page that links to each of the identified pages. In some implementations, the ad creative generator 206 can generate a single abstracted ad creative using information extracted from the web page 204 that can be used as an abstracted ad creative for all three identified pages. In some implementations, the ad creative generator 206 can generate individual abstracted ad creatives for each of the identified pages.

In some implementations, the ad creative 208 includes a link 226. The link 226 can be a link to the, target page, the web page 204, another parent page that links to or is in a breadcrumb trail for the target page, or a category page for the target page. In some implementations, the link 226 can be a link to one of the sibling pages for the target page. In some implementations, the URL 220 can be used as the link 226. In some implementations, a URL for the web site that includes the web page 204 (e.g., root page of the web site) can be used as the link 226. In some implementations, the URL for the web site that includes that web page 204 can be displayed within the ad creative 208 as the link 226, while the URL 220, or a URL for the target page, is used as the actual link. For example, the URL “cellphonestore.com” is displayed in the ad creative 208 while the URL 220 “http:///www.cellphonestore.com/XK37205” is the URL for the web page that is loaded if a user selects the link 226.

In some implementations in which multiple abstracted ad creatives are generated, the ad creative generator 206 can generate a abstracted ad creative for the web page 204 using the methods described above. The abstracted ad creative can include a title generated from abstracted information extracted from the target page, the web page 204, or another page associated with the target page or the web page 204. The abstracted ad creative can also include additional text (e.g., generic additional text, or additional text derived from information extracted from a web page). The ad creative generator 206 can then generate abstracted ad creatives for each of the pages linked to by the links 216a-c by adding links for each of the pages to the originally generated abstracted ad creative. For example, the web page 204 can generate an ad creative for the page linked to by the link 216a (i.e., the target page) by adding the URL of the link 216a to the abstracted ad creative 208. In some implementations, the abstracted ad creative that is specific to target page can include a generic displayed link (e.g., “cellphonestore.com”) while selecting the ad creative will cause a link specific to the link 216a to be activated (e.g., “http://www.cellphonestore.com/phones/coolphoneco/zoomsmart/zoomsmart220/”).

In some implementations, the ad creative generator 206 can generate an abstracted ad creative using information extracted from a commercial landing page identified as being the target commercial landing page, and include a link to a category page or parent page for the target commercial landing page. For example, a query processing service can identify the pages linked to by the links 216a-c as being relevant to a received query or ad request. The page linked to by the link 216a can be identified as the most relevant of the identified commercial landing pages and therefore be identified as the target page. For example, if the received query is “Zoom Smart phone with video,” the page linked to by the link 216a can be identified as being most relevant to the query since the Zoom Smart 550 phone has digital video functionality (and the page therefore includes one or more instances of the word “video”). The pages linked to by the links 216a-b can be identified as relevant since they match the words “Zoom Smart phone” but can be less relevant since they do not match the word “video.”

Information can be extracted from the target page and used to generate an abstracted ad creative as described above. The link used in the ad creative can be the URL 220 for the web page 204 (i.e., the parent page) or for a category page associated with the target page. Therefore, the ad creative includes information derived from the target commercial landing page, while providing a link to a parent page or category page. A user can select the ad creative and be directed to the parent page (i.e., the web page 204) or category page which allows the user to see information about several types of phones and access links to several commercial landing pages identified as being relevant to the received query, including the target page which was identified as most relevant to the received query.

An ad creative generated in this manner can appeal to a user by containing text derived from a most relevant commercial landing page while giving a user who selects the ad creative more information about the most relevant commercial landing page and other relevant commercial landing pages. In some implementations, rather than using information derived from a single most relevant commercial landing page, the ad creative generator 206 can generate an ad creative using information derived from two or more most relevant commercial landing pages and include a link to a category page that links to the most relevant commercial landing pages. For example, an ad creative title can be derived from information extracted from the page linked to by the link 216a, while body text for the ad creative can be derived from the page linked to by the link 216b. The ad creative in this example can include a link to the web page 204 (i.e., the URL 220).

In some implementations, the ad creative generator 206 can generate ad creatives that include one or more images extracted from the target page, the web page 204 or pages associated with the target page. For example, the ad creative generator 206 can insert the image 218 into the ad creative 208. In some implementations, a request for an ad can indicate if the requested ad should include an image. The ad creative generator 206 can include an image in the automatically generated ad creative based on whether or not the ad request indicates if the ad creative should include an image. In some implementations, the ad creative generator 206 can identify whether an image is too specific before using the image to generate an abstracted ad creative. For example, if the image is identified as being an image of a specific product (e.g., using a file name for the image, or metadata associated with the image), the image can be discarded. However, if the image is identified as being sufficiently abstract (e.g., a logo for a particular cell phone manufacturer) the image can be used in generating an abstracted ad creative.

In some implementations, the ad creative generator 206 can generate multiple abstracted ad creatives for a web page (e.g. for the target page). The ad creative generator 206 can apply ranking scores to the multiple abstracted ad creatives in order to select one or more highest ranked abstracted ad creatives to provide in response to a received ad request. In some implementations, the ranking scores can be applied to the abstracted ad creatives as described above for the potential ad creative titles.

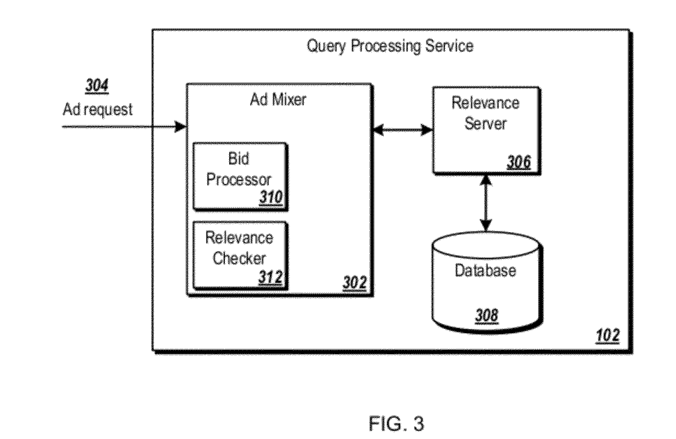

Referring now to FIG. 3, an example architecture for the query processing service system 102 is shown. The query processing service 102 can include an ad mixer 302 that receives an ad request 304. In some implementations, the ad request 304 can take the form of a user entered search query, for example, the search string 110 of FIG. 1. In some implementations, the ad request 304 can include a user entered search query, and additional information, such as profile information about a user who entered the query, or geo-location information indicating where the ad request 304 originated. The additional information can be provided on an opt in basis. That is, users of the query processing system can elect to provide the additional information or not.

In some implementations, the ad request 304 can be a request initiated by code included in a web page being loaded by a web browser. For example, a content provider can provide a web page to a client device for display to a user. The web page can include advertising slots for displaying one or more ads provided by an ad serving system. In some implementations, the query processing service 102 can serve as the ad serving system. The ad slots can be designated portions of the web page which execute code that causes the ad request 304 to be sent to the query processing service 102. In some implementations, The loading of the web page by a browser or other application can cause the ad slot code to execute and initiate the ad request 304. The ad request 304 can include keywords associated with the web page that can be used to identify commercial landing pages that are relevant to the web page.

In some implementations, the ad mixer 302 can send the received ad request 304 to a relevance server 306. The relevance server 306 can access a database 308 in order to provide one or more ad creatives in response to the ad request 304. In a first example scenario, the database 308 can include links between queries and commercial landing pages. The relevance server 306 can identify the query included in the ad request 304 within the database 308 to identify commercial landing pages that are associated with the query. In some implementations, the database 308 can be used to generate relevance scores to indicate commercial landing pages that are most relevant to the query. In some implementations, the relevance server 306 can select a set number (e.g., 3) of commercial landing pages that are identified as being most relevant to the query. In some implementations, an advertiser can provide one or more keywords in association with a commercial landing page. The keywords can be stored in the database 308 in association with links to the commercial landing pages. The keywords can be used to match keywords included in the ad request 304 to a commercial landing page. In some implementations, advertisers do not provide keywords in association with some or all of the commercial landing pages included in the database 308.

In some implementations, the relevance server 306 or an associated system can access the identified commercial landing pages and extract information from the identified commercial landing pages in order to generate abstracted ad creatives. For example, the relevance server can include or communicate with an ad creative generator (e.g., the ad creative generator 206 of FIG. 2) for generating abstracted ad creatives from information extracted from commercial landing pages. Text, images, and other information extracted from the commercial landing pages can be used to generate the ad creatives as described above with reference to FIG. 2. The ad creatives can additionally include links that link back to the commercial landing pages. In some implementations, an abstracted ad creative is generated using abstracted information derived from an identified target page. In some implementations, an abstracted ad creative is generated using abstracted information extracted from one or more of parent pages, category pages, and sibling pages for an identified target page.

In some implementations, the relevance server 306 can identify a category page or parent page that links a target commercial landing page identified as being relevant to the ad request 304. In some implementations, the relevance server 306 can generate an abstracted ad creative using information extracted from the category page or the parent page and include a link to the category page or the parent page in the abstracted ad creative. In some implementations, the relevance server 306 can generate an abstracted ad creative using information extracted from a target commercial landing page (e.g. a page that is identified as being most relevant to the ad request 304), and include a link to the target page, a category page, or a parent page for the target pge in the abstracted ad creative. In some implementations, the abstracted ad creative can be generated as a category ad creative. The category ad creative can be generated using data extracted from the target page. The extracted data can be parsed to identify category information that relates to a particular category of products or services that includes a product or service identified by the target page, while not being specific to a particular product or service. The identified category information can be used to generate the category ad creative.

In some implementations, the abstracted ad creative can be a parent ad creative. The parent ad creative can be generated using information extracted from a parent page for the target page. The extracted information can be parsed to identify and exclude information that relates to specific products or services (e.g., a specific product described by the target page). The remaining information can be identified as abstracted information and used in generating the abstracted parent ad creative.

In some implementations, an ad creative can be generated using information extracted from multiple identified commercial landing pages including target pages, parent pages, category pages, and sibling pages.

In some implementations, generating an ad creative using information extracted from a commercial landing page can include identifying a title for the commercial landing page or other important text of the commercial landing page. For example, a title for a commercial landing page can be identified by HTML tags within HTML code for the commercial landing page. The HTML tags can include title tags, header tags, bold tags, italics tags, underlining tags, font tags, color tags, or size tags. In some implementations, other methods aside from identifying tags can be used to identify emphasized features such as bolding, italics, underlining, font, color, or size. In some implementations, text having a different font, size, color, or other attribute from other text included in a commercial landing page can be identified as a title for the commercial landing page. In some implementations, position of text within a commercial landing page can be used to identify a title for the commercial landing page. For example, text that is located near the top and/or center of the commercial landing page can be identified as a title for the commercial landing page. In some implementations, multiple text segments can be identified as titles for a commercial landing page. For example, several different character strings of bold text can be identified as titles for the commercial landing page. In some implementations, titles can be identified within web pages linked to by an identified commercial landing page. In some implementations, titles can be identified within web pages that are linked to by a category page that also links to a an identified commercial landing page.

In a second example scenario, the database 308 can include links between queries or keywords and ad creative data structures that include metadata associated with commercial landing pages. An ad creative data structure can include, for example, information extracted from a commercial landing page or pages associated with a commercial landing page that can be used to generate an abstracted ad creative for the commercial landing page. In some implementations, the information can include one or more titles extracted from a header of a commercial landing page (e.g., a page title, a header, or prominent text), one or more images, and a destination URL for the commercial landing page or a web page associated with the commercial landing page. For example, if a commercial landing page includes bolded text that reads “Brand X Basketballs,” the text can be identified as a title for the commercial landing page and used as a title for an ad creative generated in association with the commercial landing page.

In some implementations, the information included in an ad creative data structure can be abstracted prior to be stored in the ad creative data structure. For example, information can be extracted from a target page. The information can be parsed to identify information that is too specific to a particular product or service or information that is too specific to the target page itself. The information identified as too specific can be discarded and the remaining information can be stored in the ad creative data structure. In some implementations, all information extracted from a web page can be included in the ad creative data structure and the information can be abstracted when an ad creative is generated from the ad creative data structure. In some implementations, an ad creative data structure can include information extracted from multiple web pages. For example, an ad creative data structure associated with a target page can include information extracted from the target page, one or more parent pages, one or more sibling pages, and/or one or more category pages associated with the target page.

In some implementations, some of the queries or keywords included in the database 308 can link to ad creative data structures for category pages associated with identified commercial landing pages. The category page ad creative data structures can include information extracted from category pages. In some implementations, the category page ad creative data structures can additionally include information from one or more pages linked to by the category page.

In some implementations, the ad creative data structure can include text extracted from anchors that link to the commercial landing page. As described above, an anchor is the text associated with a hyperlink that links to the commercial landing page. For example, a link on a first web page that links to a second web page where a user can purchase flowers can include anchor text reading “Flowers delivered to your door.” The anchor text extracted from the first web page can be stored in an ad creative data structure for the second web page and subsequently used as a title or other text for an ad creative for the second web page.

In some implementations, the ad creative data structure can include segmentation data that identifies n-grams in a title or other text associated with a commercial landing page. For example, a title for a commercial landing page can be “Surf Boards and Wet Suits by Brand XYZ.” Segmentation data stored in an ad creative data structure for the commercial landing page can indicate 2 word n-grams (i.e., bi-grams) identified in the title as “Surf Boards,” “Wet Suits,” and “Brand XYZ.” In some instances, identifying n-grams can include identifying two or more words that should not be split up. In some implementations, the determination can be based on how often the two or more words appear together or whether the identified words provide context. For example, the words “size thirteen” can be identified as an n-gram since the two words together provide context which would be lost if they are separated.

In some implementations, the database 308 can be populated with links between queries and the ad creative data structures when queries are identified that resolve to commercial landing pages. Each time a query is identified as resolving to a commercial landing page, the query can be associated with an ad creative data structure for the commercial landing page in the database 308. If an ad creative data structure for the commercial landing page does not already exist within the database 308, an ad creative data structure can be generated for the commercial landing page and stored in the database 308. In some implementations, the database 308 can be populated with links between queries and ad creative data structures. For example, one or more commercial landing pages can be identified as being relevant to a query. A category page that links to the one or more commercial landing pages can be identified and a link between the query and the category page or an ad creative data structure for the category page can be stored in the database 308.

In some implementations, advertisers can provide keywords for one or more commercial landing pages. The keywords can be linked to the ad creative data structures associated with the commercial landing pages within the database 308 and used to match queries or keywords included in the ad request 304 to ad creative data structures. In some implementations, keywords are not provided for the commercial landing pages. In some implementations, queries that resolve to commercial landing pages are identified as described above and the queries are linked to ad creative data structures associated with the commercial landing pages within the database 308.

The information included in the ad creative data structures can be used to generate abstracted ad creatives for the associated commercial landing pages. In some implementations, the relevance server 306 (or an ad creative generator associated with the relevance server) can generate multiple abstracted ad creatives using a single identified ad creative data structure. In some implementations, the relevance server 306 can apply ranking scores to the abstracted ad creatives in order to identify a highest ranked abstracted ad creative for the associated commercial landing page. In some implementations, ranking scores can be at least partially based on relevance of an ad creative to the ad request 304. In some implementations, other attributes of ad creatives can be used to apply ranking scores. Attributes that can be used to rank the ad creatives can include length of title or other text, number of words, number of n-grams, intersection of title or other text with a received query (e.g., number of words matched or percentage of words matched), size of the ad creative, shape of the ad creative, number of images in the ad creative, relevance of images in the ad creative, number of prepositions or location of prepositions, number of short words (e.g., articles), reference to specific product/service names, reference to specific product numbers, reference to specific product/service features, or reference to a specific brand name in the title or other text. In some implementations, a higher ranking score can be applied to an ad creative that links to a category page or parent page than to an ad creative that does not link to a category page or parent page. In some implementations, an abstracted ad creative that is generated using information extracted from a category page or parent page can be given a higher ranking than an ad creative that is not generated from information extracted from a category page or parent page. In some implementations, upon applying ranking scores, the relevance server 306 can select one or more highest ranked ad creatives to provide in response to the ad request 304.

In a third example scenario, the database 308 can include links between queries and abstracted ad creatives for commercial landing pages. In some implementations, the database 308 can be populated with query/ad creative pairs as queries are identified as resolving to commercial landing pages. In some implementations, the database 308 can be populated with keywords/ad creative pairs where the keywords are provided by advertisers. In some implementations, the ad creatives can be generated from information extracted from commercial landing pages or category/parent pages as described above and stored in the database 308.

The relevance server 306 can provide generated or identified abstracted ad creatives identified as being most relevant to the ad request 304 to the ad mixer 302. In some implementations, the ad creatives provided by the relevance server 306 can include ad creatives for multiple advertisers associated with commercial landing pages that are relevant to the ad request 304. In some implementations, multiple ad creatives can be provided by the relevance server 306 for a single commercial landing page identified as being relevant to the ad request 304.

The ad mixer 302 can add the received ad creatives to a database of ad creatives that includes other ad creatives, including ad creatives provided by advertisers. In some implementations, the ad mixer 302 can use conventional ad selection methods to identify ads to supply in response to the ad request 304. For example, the ad mixer 302 can include a bid processor 310. The bid processor 310 can process bids for advertisers associated with the automatically generated ad creatives as well as ad creatives that are provided directly by advertisers in order to select one or more ads having the highest bids to provide in response to the ad request 304.

In some implementations, if multiple ad creatives are associated with bids that are tied for the highest bid, or if a bidding process is not used to select ad creatives, the ad mixer 302 can use a relevance checker 312 to identify ads that are the most relevant to the ad request 304. In addition to identifying ad relevance based on relevance to a query included in the ad request 304, other information associated with the ad request can be used to apply relevance scores to ad creatives. Additional information can be provided by the user in an opt in system. Additional information that can be used to apply relevance scores to ad creatives can include geo-location information (e.g., location where ad request 304 originated, or location of a business associated with an ad), demographic information, or time stamp information. For example, if the query is for “restaurant” and the time of day in the area where the ad request 304 originated is 1:00 am, ads for all night diners can be identified as being most relevant to the query, whereas if the time of day is 10:00 am, ads for restaurants specializing in brunch can be identified as being most relevant. As another example, if the query is “men's shirts,” demographic information for a user associated with the ad request 304 can be used to identify clothing ads that would most appeal people located in a same geographic area as the user.

Ads identified by the bid processor 310 and/or the relevance checker 312 (e.g., as having winning bids or being the most relevant) can be supplied by the ad mixer 302 to an end user system (e.g., the client device 104 of FIG. 1) for presentation to an end user. In some implementations, the ads provided by the ad mixer 302 can include both automatically generated ads and ads provided directly by advertisers.

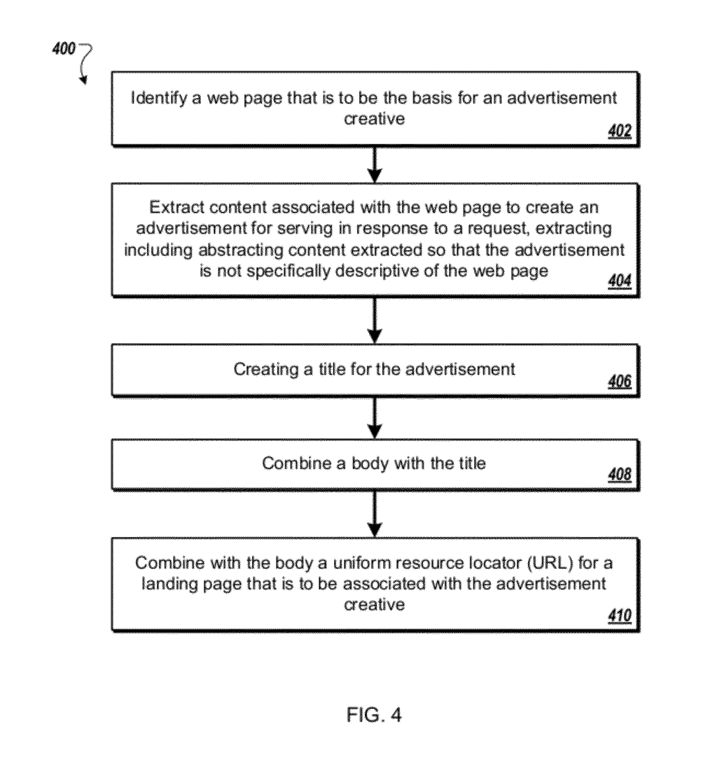

Referring now to FIG. 4, a method 400 is shown for generating an abstracted advertisement creative using information extracted from a web page. The method 400 can be performed by a system, such as the query processing service 102 shown in FIG. 3, the ad creative generator 206 of FIG. 2, or the system 100 shown in FIG. 1. At stage 402, a web page that is to be the basis for an advertisement creative is identified. For example, a query entered by an end user can be received by a query processing service. The query processing service can access a database that contains links between queries and web pages (e.g., commercial landing pages). The query processing service can compare the received query to queries contained in the database to identify a web page associated with the query. In some implementations, rather than access a database of query/web page pairs, the query processing service can perform a search of commercial landing pages to identify a commercial landing page that is a match for the received query.

In some implementations, rather than identifying a web page in response to a received query or a received ad request, a web page can be identified by an advertiser. For example, an advertiser can indicate one or more web pages to an ad creative generator. The ad creative generator can then access the indicated web pages. In some implementations, the one or more web sites associated with an advertiser can be searched to identify pages included in the web sites that are not currently targeted for advertising purposes. For example, a sporting goods manufacturer can have a web site that includes web pages that provide information on products sold by the sporting goods manufacturer. In some instances, the web pages can allow users to purchase the sporting goods. In some implementations, the ad serving system can identify product pages for which ads are not currently being served to end users. In some implementations, the ad serving system can determine if identified web pages are in fact associated with a purchasable product or service.

In some implementations, the identified web page can be a parent page for a target commercial landing page. A parent page can be a page that links to the target commercial landing page, or is included in a breadcrumb trail of pages that links to the target commercial landing page. In some implementations, the identified web page can be a category page for a target commercial landing page. The category page can be a page that relates to a general category that includes a specific product or service associated with the target commercial landing page. In some implementations, the identified web page can be a sibling page, or a page linked to by a category page or parent page.

At stage 404, content associated with the web page is extracted to create an advertisement for serving in response to a request, extracting including abstracting content extracted so that the advertisement is not specifically descriptive of the web page. Content that can be extracted from a web page can include text, images, and/or network addresses (e.g., URLs). In some implementations, extracting a title for the web page can include identifying anchor text for links located on other web pages that link to the identified web page. In some implementations, extracting content can include identifying URLs or network addresses for other web pages associated with the identified web page. In some implementations, the identified web page can include multiple titles and extracting a title for the web page can include extracting one or more of the multiple titles for the web page. In some implementations, a title for the web page can be identified by tags (e.g., HTML title or header tags), or emphasis (e.g., font size, italics, bolding, underlining, color, font, or position) on the page. For example, a character string that contains six words and is positioned between two long paragraphs can be identified as a title for the web page. As another example, bolded text located near the top of the web page can be identified as a title. As yet another example, text that appears in a different font than the majority of the other text of the web page can be identified as a title. In some implementations, the content extracted from the web page can be stored in a database. For example, the extracted content can be stored as metadata within an ad creative data structure.

Abstracting the extracted content can include removing information that is specific to a product or service identified by the web page. For example, a web page can describe a specific car model. Information that relates to the specific car model (model name, model number, specific features) can be removed from the extracted information. The abstracted information can be information that relates generally to a particular category of car that includes the specific car model, or to a particular car manufacturer that produces the specific car model. As another example, information relating to a product name and product number for a specific model of printer can be removed from the extracted content in order to abstract the content. The abstracted content can include content that relates to a general category of printers, or to printers in general, but not to the specific printer model.

At stage 406, a title for the advertisement is created. In some implementations, the creating can include computing a snippet of the title based on the request and the abstracted content. For example, a query or keywords included in the request can be compared to the abstracted content to identify portions of the abstracted content that are most relevant to the received request. The portions of the abstracted content that are identified as most relevant can be used to create a title for the ad creative. In some implementations, n-grams included in the abstracted content can be identified. The title for the ad creative can be created such that words that make up n-grams identified in the abstracted content are not separated from each other. In some implementations, n-grams that have the highest rate of intersection with a received query or keywords can be combined to create the ad creative title. In some implementations, creating an ad creative title can include creating multiple potential ad creative titles and applying ranking scores to the ad creative titles based on various attributes of the ad creative titles. A potential ad creative title having the highest ranking score can be selected as the ad creative title

At stage 408, a body is combined with the title. For example, referring to FIG. 2, the generated ad creative title 224 can be combined with a body of “Get the best electronics at the lowest prices.” In some implementations, the body that is combined with the ad creative title can be generic text that is used for multiple ad creatives. For example, an advertiser can specify two lines of generic text to be used as a body for all ad creatives generated for web pages included in a particular web site. In some implementations, the body can be dynamically generated using extracted content associated with the web page, information included in the received request, or a combination of both. In some implementations, the body can be generated in a similar manner as that described above for generating the ad creative title. For example, an intersection between a query included in the received request and abstracted content derived from the web page can be identified. The section of abstracted content that intersects with the query can be used to create the body for the ad creative.

At stage 410, the body is combined with a uniform resource locator (URL) for a landing page that is to be associated with the advertisement creative. In some implementations, the URL for the landing page can be the URL of the web page identified at stage 402. In some implementations, the URL for the landing page can be a URL for a web page associated with the identified web page. For example, a URL for a front page of a web site that includes that identified web page can be used as the URL for the landing page. In some implantations, a URL for a parent page, a category page, or a sibling page can be used in the abstracted ad creative. In some implementations, a first URL can be displayed in the ad creative while a second URL is used to access a landing page upon selection of the ad creative. For example, an ad creative can display a URL of “onlinesportsstore.net” and include a link through URL of “http://www.onlinesportsstore.net/equipment/badminton/shuttlecocks.”

In some implementations, the method 400 can include fewer or additional steps. For example, the method 400 can include a step of identifying n-grams within the abstracted content. In some implementations, steps of the method 400 can be performed in a different order. For example, the step of combining the body with the URL can be performed before the step of combining the body with the ad creative title.

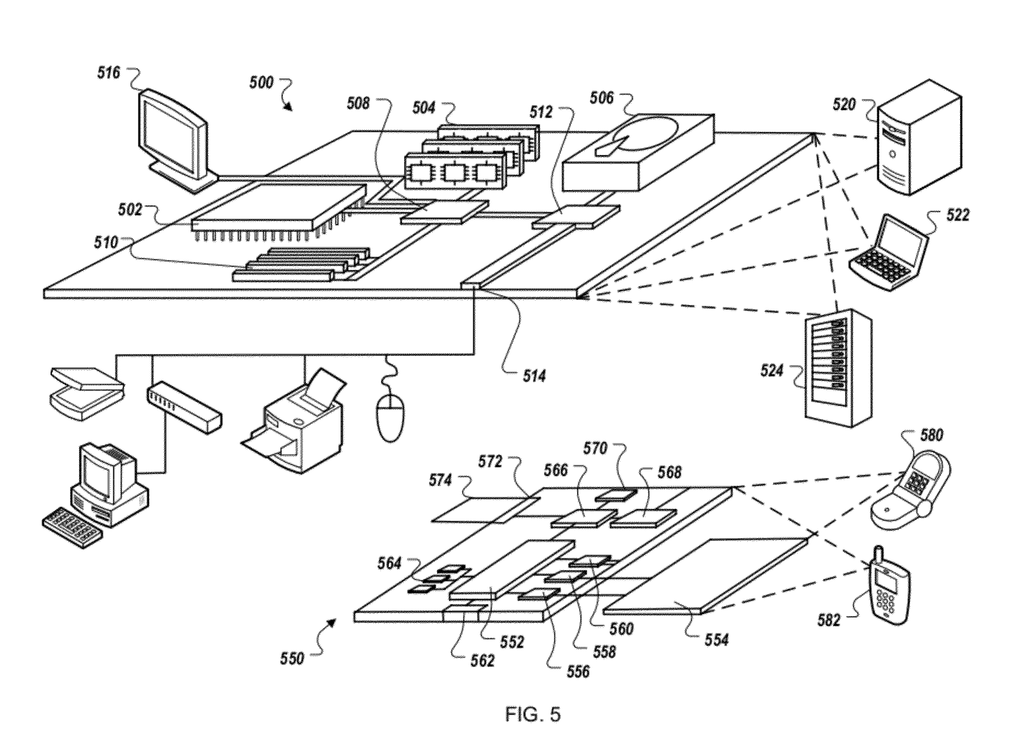

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or a memory on processor 502.

The high speed controller 508 manages bandwidth-intensive operations for the computing device 500, while the low speed controller 512 manages lower bandwidth-intensive operations. Such allocation of duties is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communication audibly using audio codec 560, which may receive spoken information from a user and convert it to usable digital information. Audio codex 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
identifying a web page that is to be a basis for an advertisement creative;
extracting content associated with the web page to create an advertisement for serving in response to a request, extracting including abstracting content extracted so that the advertisement is not specifically descriptive of the web page;
creating a title for the advertisement;
combining a body with the title; and
combining with the body a uniform resource locator (URL) for a landing page that is to be associated with the advertisement creative.

2. The method of claim 1 where the advertisement is a category advertisement that describes a category of goods or services of which the web page includes at least one specific example.

3. The method of claim 2 where the URL is for a page associated with the category.

4. The method of claim 1 where the advertisement is a parent advertisement that describes a parent page that is at least one level higher in a hierarchy above the web page in a web site hierarchy that includes the web page.

5. The method of claim 4 where the URL is for the parent page.

6. The method of claim 1 where the URL is for the web page.

7. The method of claim 1 where abstracting content extracted includes determining extracted content selected from the group of at least one of a title associated with the web page, a header associated with the web page or emphasized content associated with the web page.

8. The method of claim 7 further comprising abstracting the extracted content.

9. The method of claim 8 wherein abstracting the extracted content further comprises determining a category associated with a specific product or service described by the web page.

10. The method of claim 9 further comprising using the category in determining the title of the advertisement.

11. The method of claim 9 further comprising determining a category page associated with the category and extracting content from the category page for use in creating the advertisement.

12. The method of claim 11 further comprising using content extracted from the category page in creating the title.

13. The method of claim 8 wherein abstracting extracted content further comprises determining a parent associated with the web page.

14. The method of claim 13 further comprising using the parent in determining the title of the advertisement.

15. The method of claim 14 further comprising determining a parent page associated with the parent and extracting content from the parent page for use in creating the advertisement.

16. The method of claim 15 further comprising using content extracted from the parent page in creating the title.

17. The method of claim 1 wherein the request is a query.

18. The method of claim 1 wherein the request is a request for one or more advertisements to be published along with other content on a serving page.

19. The method of claim 1 wherein the body includes two lines and is based on content on the web page.

20. The method of claim 1 wherein the body includes two lines and is generic and not specifically related to the web page.

21. The method of claim 1 wherein extracting includes identifying text that is in a larger font than other text in the web page.

22. The method of claim 1 wherein extracting includes identifying anchors associated with the web page.

23. The method of claim 1 wherein extracting includes identifying bi-grams and/or other n-grams in the extracted content.

24. The method of claim 1 wherein extracting includes:
identifying a title of the web page;
identifying and stripping non-essential material from within the title to create a stripped title;
segmenting the stripped title into known compounds to create an extracted title; and wherein creating the title for the advertisement creative includes
computing the intersection between the request and the extracted title.

25. The method of claim 24 wherein creating the title for the advertisement further includes:
generating all possible title snippets using a number of algorithmic rules;
scoring the title snippets; and
selecting a best snippet from the scored snippets for use as the advertisement creative title.

26. The method of claim 25 wherein combining a body further includes combining a best title with generic text.

27. The method of claim 26 wherein combining a URL further includes combining a URL for an advertiser associated with the web page and link to a specific page to the body.

28. A method comprising:
identifying a content item from a content source that is to be a basis for an advertisement creative;
extracting content associated with the content item to create an advertisement for serving in response to a request, extracting including abstracting content extracted so that the advertisement is not specifically descriptive of the content item;
creating an advertisement creative title for the advertisement creative based on the request and the extracted content;
combining a body with the advertising creative title; and
combining with the body a uniform resource locator (URL) for a landing page that is to be associated with the advertisement creative.

29. The method of claim 28 where the advertisement is a category advertisement that describes a category of goods or services of which the content item includes at least one specific example.

30. The method of claim 29 where the URL is for a page associated with the category.

31. The method of claim 28 where the advertisement is a parent advertisement that describes a parent content item that is at least one level higher in a hierarchy above the content item in a hierarchy that includes the content item.

32. The method of claim 31 where the URL is for the parent content item.

33. The method of claim 28 where the URL is for the content item.

34. The method of claim 28 where abstracting content extracted includes determining extracted content selected from the group of at least one of a title associated with the content item, a header associated with the content item or emphasized content associated with the content item.

35. The method of claim 34 further comprising abstracting the extracted content.

36. The method of claim 35 wherein abstracting the extracted content further comprises determining a category associated with a specific product or service described by the content item.

37. The method of claim 36 further comprising using the category in determining the title of the advertisement.

38. The method of claim 36 further comprising determining a category page associated with the category and extracting content from the category page for use in creating the advertisement.

39. The method of claim 38 further comprising using content extracted from the category page in creating the title.

40. The method of claim 35 wherein abstracting the extracted content further comprises determining a parent associated with the content item.

41. The method of claim 40 further comprising using the parent in determining the title of the advertisement.

42. The method of claim 41 further comprising determining a parent content item associated with the parent and extracting content from the parent content item for use in creating the advertisement.

43. The method of claim 42 further comprising using content extracted from the parent content item in creating the title.

44. The method of claim 28 wherein the request is a query.

45. The method of claim 28 wherein the request is a request for one or more advertisements to be published along with other content on a serving page.

46. The method of claim 28 wherein the body includes two lines and is based on content included in the content item.

47. The method of claim 28 wherein the body includes two lines and is generic and not specifically related to the content item.

48. The method of claim 28 wherein extracting includes identifying text that is in a larger font than other text in the content item.

49. The method of claim 28 wherein extracting includes identifying anchors associated with the content item.

50. The method of claim 28 wherein extracting includes identifying bi-grams and/or other n-grams in the extracted content.

51. The method of claim 28 wherein extracting includes:
identifying a title of the content item;
identifying and stripping non-essential material from within the title to create a stripped title;
segmenting the stripped title into known compounds to create an extracted title; and wherein creating the title for the advertisement creative includes
computing the intersection between the request and the extracted title.

52. The method of claim 51 wherein creating the title for the advertisement creative further includes:
generating all possible title snippets using a number of algorithmic rules;
scoring the title snippets; and
selecting a best snippet from the scored snippets for use as the advertisement creative title.

53. The method of claim 52 wherein combining a body further includes combining a best title with generic text.

54. The method of claim 53 wherein combining a URL further includes combining a URL for an advertiser associated with the content item and link to a specific page to the body.
